(19) United States
(12) Patent Application Publication
(10) Pub. No.: US 2004/0066514 A1
(43) Pub. Date: Apr. 8, 2004

(54) Upper compliant tooling

(76) Inventors: Victor J. Kardos, Irvine, CA (US); Charles C. Vice, Orange, CA (US); Dino Lenarduzzi, Phoenix, AZ (US); Douglas S. Hutchings, Rancho Cucamonga, CA (US)

Correspondence Address: IRELL & MANELLA LLP, 840 NEWPORT CENTER DRIVE, SUITE 400, NEWPORT BEACH, CA, 92660, US

(21) Appl. No.: 10/267,287

(22) Filed: Oct. 8, 2002

(51) Int. Cl. G01B 11/00

(52) U.S. Cl. 356/399

(57) ABSTRACT

An upper tooling assembly that includes a gripper pivotally coupled to an arm. The upper tooling assembly can be located above a lower tooling assembly that holds a first optical device. The gripper holds a second optical device that is to be aligned with the first device. The arm is coupled to a translation table that moves the second optical device into contact with the first optical device. The pivotal coupling of the gripper to the arm allows the second device to rotate and become aligned with the first device in a parallel manner. The upper tooling assembly may further include a brake that locks the position of the gripper and second optical device after alignment with the first device.

### BACKGROUND OF THE INVENTION

1. Field of the Invention

The subject matter disclosed generally relates to a tooling assembly that allows two optical components to be aligned in a parallel manner.

2. Background Information Laser diodes and photodetectors are typically assembled into a “package” that is mounted to a printed circuit board. A fiber optic cable is attached to the end of the package with a weld or solder process.

There have been developed packages that contain an array of laser diodes. A fiber optic ribbon is typically attached to such a package. The ribbon is generally rectangular in shape and contains a number of cables that are each coupled to a corresponding diode. It is important that the fiber optic ribbon be parallel with the package. A lack of parallelism may result in undesirable optical losses in the package.

To improve reliability and lower cost it is desirable to attach the ribbon to the package in an automated weld machine. The weld machine may have a tool to hold the package and a gripper to hold the ribbon. The gripper may be attached to a z-axis translation table that moves the ribbon into contact with the package to allow for the welding process. If the components are not properly aligned in the weld tools the ribbon may not be parallel with the package during and/or after the weld process.

### BRIEF SUMMARY OF THE INVENTION

A tooling assembly that includes a gripper pivotally coupled to an arm.

### BRIEF DESCRIPTION OF THE DRAWINGS

FIG. 1 is a perspective view of an upper tooling assembly;

FIG. 2 is a perspective view of the upper tooling assembly and a lower tooling assembly;

FIG. 3 is a side sectional view showing two optical devices mated by the upper tooling assembly and a lower tooling assembly;

FIG. 4 is a side view of the upper tooling assembly;

FIG. 5 is a rear perspective view showing a brake of the upper tooling assembly;

FIG. 6 is an enlarged perspective view showing a sensor of the upper tooling assembly.

### DETAILED DESCRIPTION

Disclosed is an upper tooling assembly that includes a gripper pivotally coupled to an arm. The upper tooling assembly can be located above a lower tooling assembly that holds a first optical device. The gripper holds a second optical device that is to be aligned with the first device. The arm is coupled to a translation table that moves the second optical device into contact with the first optical device. The pivotal coupling of the gripper to the arm allows the second device to rotate and become aligned with the first device in a parallel manner. The upper tooling assembly may further include a brake that locks the position of the gripper and second optical device after alignment with the first device.

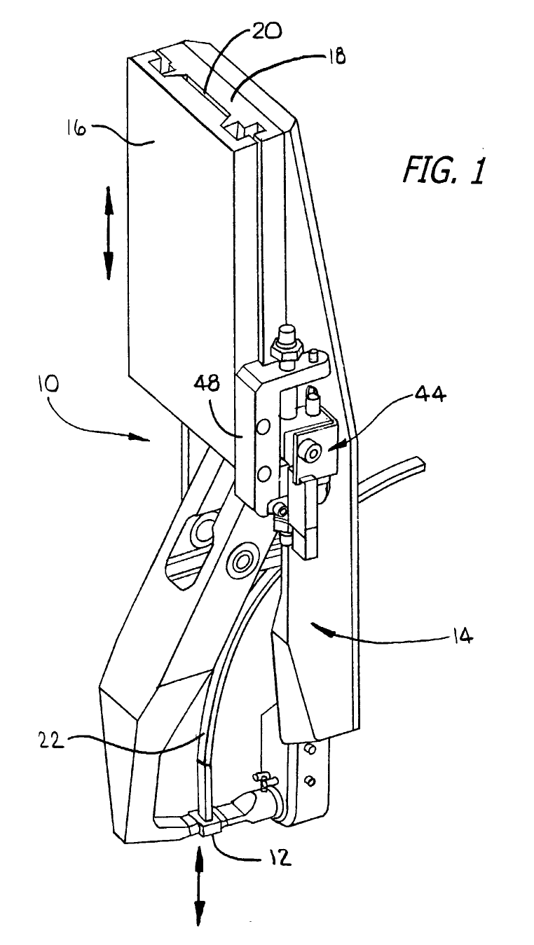

Referring to the drawings more particularly by reference numbers, FIG. 1 shows an upper tooling assembly 10. The assembly 10 includes a gripper 12 attached to an arm 14. The tooling arm 14 is attached to a z-axis translation table (not shown) that can move the arm 14 and gripper 12 in a vertical direction as indicated by the arrows. The arm 14 may include a pair of plates 16 and 18. Plate 16 can move relative to plate 18 in a linear manner along bearing groove 20. The assembly 10 may include a vacuum tube 22 that is attached to the gripper 12. The tube 22 provides vacuum pressure so that the gripper 12 can grasp a part.

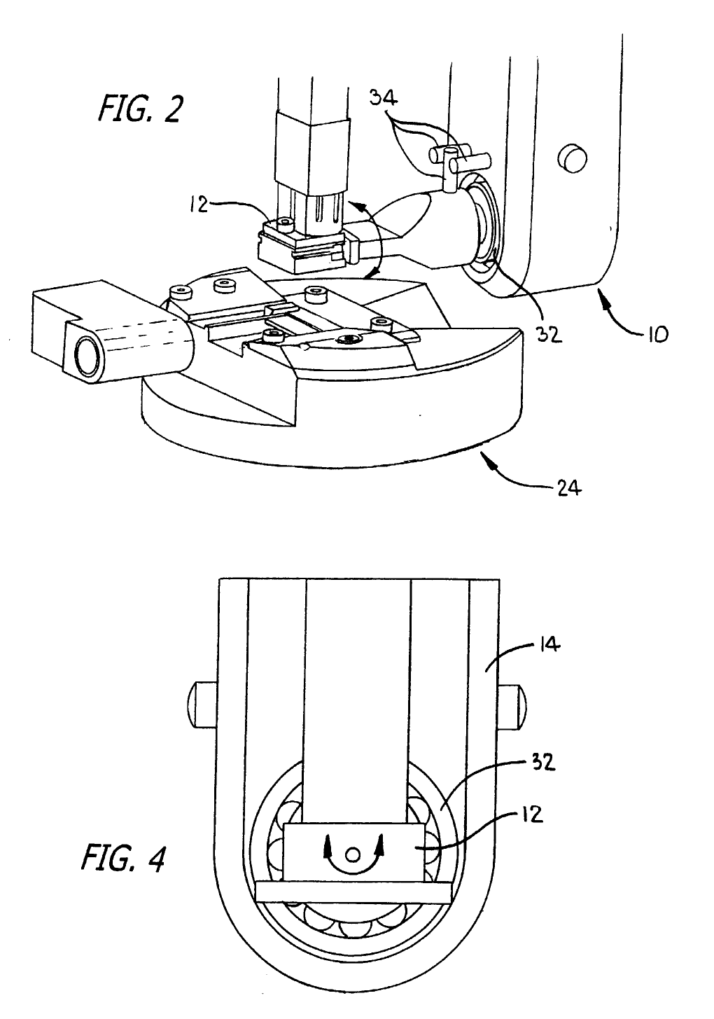

As shown in FIGS. 2 and 3, the upper tooling assembly 10 may be located above a lower tooling assembly 24. The lower tooling assembly 24 may be the same or similar to the assembly disclosed in application Ser. No. 10/200,805, which is hereby incorporated by reference.

The lower tooling assembly 24 may hold a first optical device 26. The first device 26 may be a metal package that contains a laser diode or opto-electronic device. The gripper 12 holds a second optical device 28. The second optical device 28 may be a fiber optic ribbon cable. The vacuum pressure provided by the vacuum tube (see FIG. 1) may hold the second device 28 within a slot 30 of the gripper 12. The upper 10 and lower 24 tooling assemblies may be integrated into a laser weld machine (not shown) that welds the second device 28 to the first device 26. Although a laser diode package and fiber ribbon are shown and described, it is to be understood that the upper 10 and lower 24 tooling assemblies can hold different optical, or opto-electrical parts.

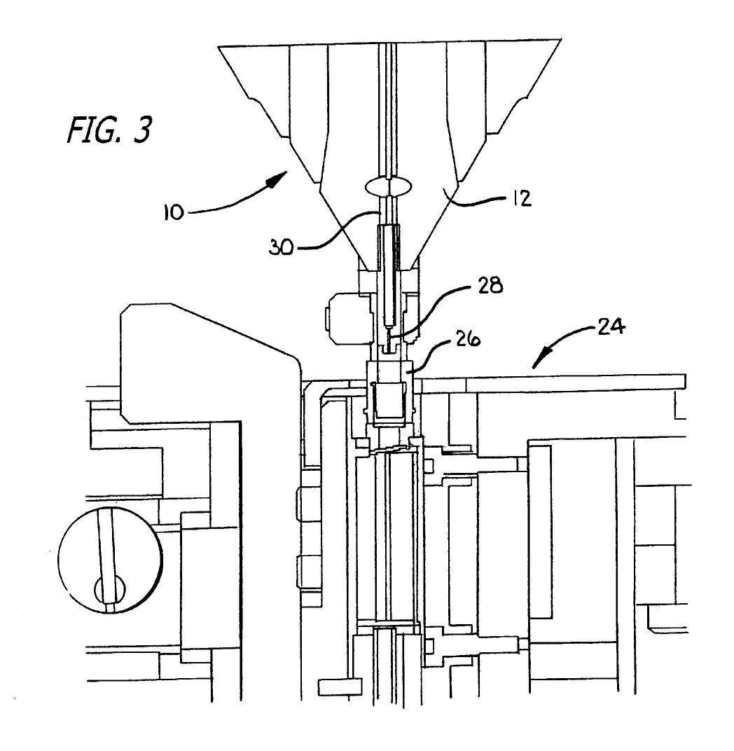

As shown in FIG. 4, the gripper 12 is pivotally coupled to the arm 14 by a bearing assembly 32. The bearing assembly 32 allows the gripper 12 to pivot as indicated by the arrows. This pivoting movement allows the second optical device to be flush and parallel with the first optical device. Referring to FIG. 2, the upper tooling assembly 10 may contain a plurality of stop pins 34 that limit the amount of pivot by the gripper 12.

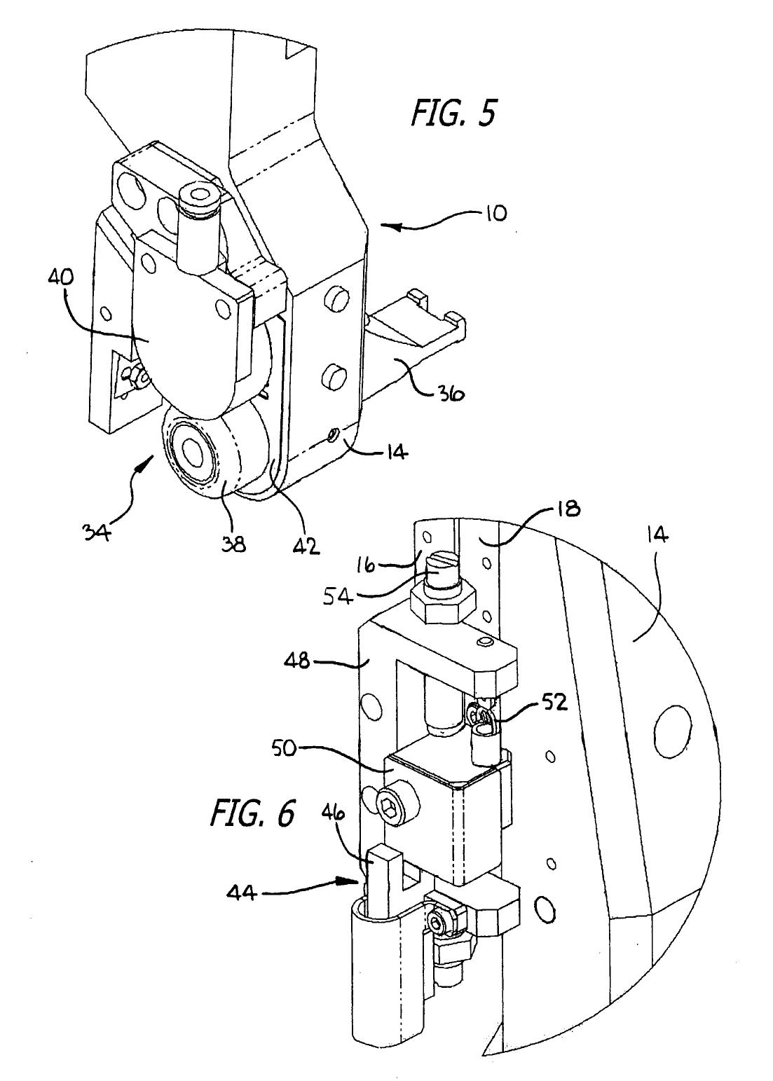

As shown in FIG. 5, the upper tooling assembly 10 may include a brake 34 that locks the position of the gripper and the second device. The gripper (not shown in FIG. 5) may be attached to a spindle arm 36 that extends through the arm 14 and includes a brake collar 38. The brake 34 includes an actuator 40 that is attached to the arm 14 and coupled to a friction brake plate 42. To the lock the gripper, the actuator 40 is actuated to pull the brake plate 42 into the brake collar 38 of the spindle arm 36.

FIG. 6 shows a sensor assembly 44 that is attached to the arm 14. The sensor assembly 44 includes a sensor 46 that is attached to arm plate 16 by a sensor bracket 48, and a flag 50 that is attached to the arm plate 18. A biasing spring 52 may be attached to the flag 50. The tension of the spring 52 may be adjusted by tension screw 54. The sensor 46 and brake actuator 40 can be connected to an electrical circuit that automatically activates the brake 34 when the sensor 46 does not sense the flag 50.

In operation, the arm 14 moves in a downward direction so that the second device 28 makes contact with the first device 26. The bearing assembly 32 allows the gripper 12 to pivot so that continued downward movement will allow the second device 28 to rotated and become aligned with the first device 26. The downward movement of the gripper 12 also creates a pressure that pushes the devices 26 and 28 into alignment. The force of the spring 52 establishes the pressure exerted by the devices 26 and 28.

The engagement of the devices 26 and 28 prevents further downward movement of the gripper 12. The translation table continues to move the plate 16 and the attached sensor 46. The plate 16 moves downward until the sensor 46 no longer senses the flag 50 at which point the arm 14 stops moving and the brake actuator 40 is actuated to lock the position of the gripper 12. The arm 14 and gripper 12 can then be moved upward to move the second device 28 away from the first device 26. By locking the gripper 12, the second device 28 is maintained in a parallel position relative to the first device 16 for subsequent processing such as laser welding.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An upper tooling assembly for an optical device, comprising:
an arm; and,
a gripper pivotally coupled to said arm.

2. The assembly of claim 1, further comprising a brake coupled to said gripper and said arm.

3. The assembly of claim 1, further comprising a sensor coupled to said gripper.

4. The assembly of claim 1, further comprising a vacuum line coupled to said gripper.

5. The assembly of claim 1, wherein said arm includes a pair of plates.

6. The assembly of claim 1, further comprising a spring coupled to said arm and said gripper.

7. A tooling assembly for aligning a first optical device with a second optical device, comprising:
a lower tooling assembly that holds the first optical device; and,
an upper tooling assembly that includes an arm and a gripper, said gripper holds the second optical device and is pivotally coupled to said arm.

8. The assembly of claim 7, further comprising a brake coupled to said gripper and said arm.

9. The assembly of claim 7, further comprising a sensor coupled to said gripper.

10. The assembly of claim 7, further comprising a vacuum line coupled to said gripper.

11. The assembly of claim 7, wherein said arm includes a pair of plates.

12. The assembly of claim 7, further comprising a spring coupled to said arm and said gripper.

13. An upper tooling assembly for an optical device, comprising:
an arm;
gripper means for holding the optical device; and,
pivot means for allowing said gripper means to pivot relative to said arm.

14. The assembly of claim 13, further comprising brake means for locking said gripper to said arm.

15. The assembly of claim 13, further comprising sensor means for sensing a pressure exerted on the optical device.

16. The assembly of claim 13, wherein said pivot means includes a bearing assembly.

17. The assembly of claim 13, wherein said arm includes a pair of plates.

18. The assembly of claim 15, further comprising spring means for establishing the pressure.

19. A method for aligning a first optical device with a second optical device, comprising:
moving the second optical device into contact with the first optical device with a gripper that is pivotally coupled to an arm; and,
pivoting the second optical device relative to the first optical device.

20. The method of claim 19, further comprising locking a position of the second optical device.
